(19) United States
(12) Patent Application Publication
(10) Pub. No.: US 2014/0241929 A1
(43) Pub. Date: Aug. 28, 2014

(54) RARE-EARTH PERMANENT MAGNET AND METHOD FOR MANUFACTURING RARE-EARTH PERMANENT MAGNET

(71) Applicant: NITTO DENKO CORPORATION, Ibaraki-shi, Osaka (JP)

(72) Inventors: Takashi Ozaki, Ibaraki-shi (JP); Katsuya Kume, Ibaraki-shi (JP); Toshiaki Okuno, Ibaraki-shi (JP); Izumi Ozeki, Ibaraki-shi (JP); Tomohiro Omure, Ibaraki-shi (JP); Keisuke Taihaku, Ibaraki-shi (JP); Takashi Yamamoto, Ibaraki-shi (JP)

(21) Appl. No.: 14/241,511

(22) PCT Filed: Sep. 25, 2012
(86) PCT No.: PCT/JP2012/074471

§ 371 Date: Feb. 27, 2014

(30) Foreign Application Priority Data
Sep. 30, 2011 (JP) 2011-218589

(51) Int. Cl. H01F 41/02; H01F 1/053

(52) U.S. Cl. CPC H01F 41/0266; H01F 1/0536
USPC 419/33; 75/228

(57) ABSTRACT

There are provided a rare-earth permanent magnet and a manufacturing method of the rare-earth permanent magnet with improved magnetic performance which is achieved through milling-ability-improved fine wet-milling step. In the method, coarsely milled magnet material is finely wet-milled in an organic solvent together with an organometallic compound expressed with a structural formula of M-(OR)ₓ (M including at least one of Nd, Al, Cu, Ag, Dy, Tb, V, Mo, Zr, Ta, Ti, W, and Nb, R representing a substituent group consisting of a straight-chain or branched-chain hydrocarbon with carbon chain length of 2-16, and ₓ representing an arbitrary integer) to obtain magnet powder and to make the organometallic compound adhere to particle surfaces of the magnet powder. Subsequently, the magnet powder having adhesion of the organometallic compound to particle surfaces thereof is formed into a formed body and sintered so as to obtain a permanent magnet 1.

### TECHNICAL FIELD

The present invention relates to a rare-earth permanent magnet and a manufacturing method of the rare-earth permanent magnet.

### BACKGROUND ART

In recent years, a decrease in size and weight, an increase in power output and an increase in efficiency have been required in a permanent magnet motor used in a hybrid car, a hard disk drive, or the like. To realize such a decrease in size and weight, an increase in power output and an increase in efficiency in the permanent magnet motor mentioned above, a further improvement in magnetic performance has been required of a permanent magnet to be buried in the permanent magnet motor. Meanwhile, as permanent magnet, there have been known ferrite magnets, Sm—Co-based magnets, Nd—Fe—B-based magnets, Sm₂Fe₁₇Nₓ-based magnets or the like. As permanent magnet for permanent magnet motor, there are typically used Nd—Fe—B-based magnets due to remarkably high residual magnetic flux density.

As method for manufacturing a permanent magnet, a powder sintering process is generally used. In this powder sintering process, raw material is coarsely milled first and furthermore, is finely milled into magnet powder by a jet mill (dry-milling method) or a wet bead mill (wet-milling method). Thereafter, the magnet powder is put in a mold and pressed to form in a desired shape with magnetic field applied from outside. Then, the magnet powder formed and solidified in the desired shape is sintered at a predetermined temperature (for instance, at a temperature between 800 and 1150 degrees Celsius for the case of Nd—Fe—B-based magnet) for completion.

### PRIOR ART DOCUMENT

### Patent Document

Patent document 1: Japanese Registered Patent Publication No. 3298219 (pages 4 and 5)

### DISCLOSURE OF THE INVENTION

### Problem to be Solved by the Invention

Meanwhile, it has been known that the magnetic performance of a permanent magnet can be basically improved by making the crystal grain size in a sintered body significantly fine, because the magnetic characteristics of a magnet can be approximated by a theory of single-domain particles. Here, in order to make the grain size in the sintered body significantly fine, a particle size of the magnet raw material before sintering also needs to be made significantly fine.

Here, the milling methods to be employed at the milling of the magnet raw material include wet bead milling, in which a container is rotated with beads (media) put therein, and slurry of the raw material mixed in a solvent is added into the container, so that the raw material is ground and milled. The wet bead milling allows the magnet raw material to be milled into a range of fine particle size. However, even though wet bead milling was performed, the conventional method met difficulty in milling the most parts of the raw material into a range of fine particle size (for instance, particle size range between 0.1 μm and 5.0 μm).

The present invention has been made in order to solve the above-mentioned conventional problems, and an object thereof is to provide a rare-earth permanent magnet and a manufacturing method of the rare-earth permanent magnet with improved magnetic performance which is achieved by making size of sintered crystal particles significantly fine through milling-ability-improved fine wet-milling step in which raw magnet material is wet-milled in a solvent to which a specific organometallic compound is added.

### Means for Solving the Problem

To achieve the above object, the present invention provides a rare-earth permanent magnet manufactured through steps of: wet-milling magnet material in an organic solvent together with an organometallic compound expressed with a structural formula of M-(OR)ₓ (M including at least one of Nd, Al, Cu, Ag, Dy, Tb, V, Mo, Zr, Ta, Ti, W, and Nb, R representing a substituent group consisting of a straight-chain or branched-chain hydrocarbon with carbon chain length of 2-16, and ₓ representing an arbitrary integer) to obtain magnet powder of the magnet material currently milled and to make the organometallic compound adhered to particle surfaces of the magnet powder; forming the magnet powder having the organometallic compound adhere to particle surfaces thereof into a formed body; and sintering the formed body.

In the above-described rare-earth permanent magnet of the present invention, R in the structural formula is an alkyl group.

In the above-described rare-earth permanent magnet of the present invention, in the step of forming the magnet powder into the formed body, a slurry is prepared by mixing the magnet powder, the organic solvent and binder resin, and the slurry is formed into a sheet-like shape so as to obtain a green sheet as the formed body.

In the above-described rare-earth permanent magnet of the present invention, before the step of sintering the formed body, the binder resin is decomposed and removed from the formed body by holding the formed body for a predetermined length of time at binder resin decomposition temperature in a non-oxidizing atmosphere.

In the above-described rare-earth permanent magnet of the present invention, when decomposing and removing the binder resin from the formed body, the formed body is held for the predetermined length of time at temperature range of 200 degrees Celsius to 900 degrees Celsius in a hydrogen atmosphere or a mixed gas atmosphere of hydrogen and inert gas.

To achieve the above object, the present invention provides a manufacturing method of a rare-earth permanent magnet including the steps of: wet-milling magnet material in an organic solvent together with an organometallic compound expressed with a structural formula of M-(OR)ₓ (M including at least one of Nd, Al, Cu, Ag, Dy, Tb, V, Mo, Zr, Ta, Ti, W, and Nb, R representing a substituent group consisting of a straight-chain or branched-chain hydrocarbon with carbon chain length of 2-16, and ₓ representing an arbitrary integer) to obtain magnet powder of the magnet material currently milled and to make the organometallic compound adhere to particle surfaces of the magnet powder; forming the magnet powder having the organometallic compound adhered to particle surfaces thereof into a formed body; and sintering the formed body.

In the above-described manufacturing method of a rare-earth permanent magnet of the present invention, R in the structural formula is an alkyl group.

In the above-described manufacturing method of a rare-earth permanent magnet of the present invention, in the step of forming the magnet powder into the formed body, a slurry is prepared by mixing the magnet powder, the organic solvent and binder resin, and the slurry is formed into a sheet-like shape so as to obtain a green sheet as the formed body.

In the above-described manufacturing method of a rare-earth permanent magnet of the present invention, before the step of sintering the formed body, the binder resin is decomposed and removed from the formed body by holding the formed body for a predetermined length of time at binder resin decomposition temperature in a non-oxidizing atmosphere.

In the above-described manufacturing method of a rare-earth permanent magnet of the present invention, when decomposing and removing the binder resin from the formed body, the formed body is held for the predetermined length of time at temperature range of 200 degrees Celsius to 900 degrees Celsius in a hydrogen atmosphere or a mixed gas atmosphere of hydrogen and inert gas.

### Effect of the Invention

According to the rare-earth permanent magnet of the present invention, the magnet material is wet-milled in the organic solvent together with the organometallic compound, whereby the ability to finely wet-mill the magnet material can be improved. For instance, the step of the improved wet-milling can mill most parts of the magnet material into fine particles (falling within fine particle size range of 0.1 μm through 5.0 Tim, for instance). Consequently, diameter of sintered crystal particles can be made significantly tiny and magnetic performance can be improved.

Further, the organometallic compound containing at least one of Nd, Al, Cu, Ag, Dy, Tb, V, Mo, Zr, Ta, Ti, W, Nb, etc. is added so as to make the organometallic compound adhere to particle surfaces of magnet powder and the organometallic-compound-inclusive magnet powder is subsequently sintered. Therefore, in a case of adding elements such as Nd, Al, Cu, Ag, Dy, Tb, V, Mo, Zr, Ta, Ti, W, Nb, etc. in the step of wet-milling, respective elements can be efficiently concentrated in grain boundaries of the magnet. Thereby, magnetic performance of the permanent magnet can be improved. Further, since amount of elements to be added to the magnet can be lessened in comparison with amount of elements to be added to a conventional magnet, decrease of residual magnetic flux can be prevented.

Further, the organometallic compound can be dissolved in a general purpose solvent such as toluene or the like, whereby the organometallic compound can properly get adhered to particle surface of the magnet powder.

Further, according to the rare-earth permanent magnet of the present invention, the organometallic compound consisting of an alkyl group is used as organometallic compound to be added to magnet powder. Therefore, thermal decomposition of the organometallic compound can be caused easily. Consequently, during calcination, carbon content in the formed body can be reduced more reliably.

Further, according to the rare-earth permanent magnet of the present invention, the permanent magnet is obtained by sintering a green sheet formed from slurry prepared by mixing the magnet power, the organic solvent and binder resin together. Therefore, the thus obtained green sheet has property to uniformly contract through sintering and deformations such as warpage and depressions do not occur there. Further, the sintered green sheet having uniformly contracted gets pressed uniformly, which eliminates adjustment process to be conventionally performed after sintering and helps simplify manufacturing process. Thereby, a permanent magnet can be manufactured at highly accurate dimension. Even if above such permanent magnets are manufactured thin, increase in the number of manufacturing processes can be avoided without lowering a material yield.

Further, according to the rare-earth permanent magnet of the present invention, the green sheet is held for a predetermined length of time at binder-resin decomposition temperature in a non-oxidizing atmosphere before being calcined so that the binder resin is decomposed and removed from the green sheet. Thereby, carbon content in the magnet can be reduced previously. Consequently, previous reduction of carbon content can prevent alpha iron from separating out in a main phase of the sintered magnet and entirety of the magnet can be sintered densely. Thereby, decrease in the coercive force can be prevented.

Further, according to the rare-earth permanent magnet of the present invention, the green sheet to which the binder resin has been mixed is calcined in a hydrogen atmosphere or a mixed gas atmosphere of hydrogen and inert gas. Thereby, carbon content in the magnet can be reduced reliably.

According to the manufacturing method of a rare-earth permanent magnet of the present invention, the magnet material is wet-milled in the organic solvent together with the organometallic compound, whereby the ability to finely wet-mill the magnet material can be improved. For instance, the step of the improved wet-milling can mill most parts of the magnet material into fine particles (falling within fine particle size range of 0.1 μm through 5.0 μm, for instance). Consequently, diameter of sintered crystal particles can be made significantly tiny and magnetic performance can be improved.

Further, the organometallic compound containing Nd, Al, Cu, Ag, Dy, Tb, V, Mo, Zr, Ta, Ti, W, Nb, etc. is added so as to make the organometallic compound adhere to particle surfaces of magnet powder and the organometallic-compound-inclusive magnet powder is subsequently sintered. Therefore, in a case of adding elements such as Nd, Al, Cu, Ag, Dy, Tb, V, Mo, Zr, Ta, Ti, W, Nb, etc. in the step of wet-milling, respective elements can be efficiently concentrated in grain boundaries of the magnet. Thereby, magnetic performance of the permanent magnet can be improved. Further, since amount of elements to be added to the magnet can be lessened in comparison with amount of elements to be added to a conventional magnet, decrease of residual magnetic flux can be prevented.

Further, the organometallic compound can be dissolved in a general purpose solvent such as toluene or the like, whereby the organometallic compound can properly get adhered to particle surface of the magnet powder.

Further, according to the manufacturing method of a rare-earth permanent magnet of the present invention, the organometallic compound consisting of an alkyl group is used as organometallic compound to be added to magnet powder. Therefore, thermal decomposition of the organometallic compound can be caused easily. Consequently, during calcination, carbon content in the formed body can be reduced more reliably.

Further, according to the manufacturing method of a rare-earth permanent magnet of the present invention, the permanent magnet is obtained by sintering a green sheet formed from slurry prepared by mixing the magnet power, the organic solvent and binder resin together. Therefore, the thus obtained green sheet has property to uniformly contract through sintering and deformations such as warpage and depressions do not occur there. Further, the sintered green sheet having uniformly contracted gets pressed uniformly, which eliminates adjustment process to be conventionally performed after sintering and helps simplify manufacturing process. Thereby, a permanent magnet can be manufactured at highly accurate dimension. Even if above such permanent magnets are manufactured thin, increase in the number of manufacturing processes can be avoided without lowering a material yield.

Further, according to the manufacturing method of a rare-earth permanent magnet of the present invention, the green sheet is held for a predetermined length of time at binder-resin decomposition temperature in a non-oxidizing atmosphere before being calcined so that the binder resin is decomposed and removed from the green sheet. Thereby, carbon content in the magnet can be reduced previously. Consequently, previous reduction of carbon content can prevent alpha iron from separating out in a main phase of the sintered magnet and entirety of the magnet can be sintered densely. Thereby, decrease in the coercive force can be prevented.

Further, according to the manufacturing method of a rare-earth permanent magnet of the present invention, the green sheet to which the binder resin has been mixed is calcined in a hydrogen atmosphere or a mixed gas atmosphere of hydrogen and inert gas. Thereby, carbon content in the magnet can be reduced reliably.

### BRIEF DESCRIPTION OF THE DRAWINGS

FIG. 1 is an overall view of a permanent magnet according to the invention.

FIG. 2 is an enlarged schematic view in vicinity of grain boundaries of the permanent magnet directed to the invention.

FIG. 3 is a view depicting an effect at sintering on a basis of improved thickness precision in a green sheet according to the invention.

FIG. 4 is a view depicting an effect at sintering on a basis of improved thickness precision in a green sheet according to the invention.

FIG. 5 is an explanatory diagram illustrating manufacturing processes of a permanent magnet according to the invention.

FIG. 6 is an explanatory diagram specifically illustrating a formation process of the green sheet in the manufacturing process of the permanent magnet according to the invention.

FIG. 7 is an explanatory diagram specifically illustrating a pressure sintering process of the green sheet in the manufacturing process of the permanent magnet according to the invention.

FIG. 8 is an enlarged image of wet-milled magnet powder for a permanent magnet directed to embodiment 1.

FIG. 9 is an enlarged image of wet-milled magnet powder for a permanent magnet directed to embodiment 2.

FIG. 10 is an enlarged image of wet-milled magnet powder for a permanent magnet directed to embodiment 3.

FIG. 11 is an enlarged image of wet-milled magnet powder for a permanent magnet directed to comparative example 1.

### BEST MODE FOR CARRYING OUT THE INVENTION

A specific embodiment of a rare-earth permanent magnet and a method for manufacturing the rare-earth permanent magnet according to the present invention will be described below in detail with reference to the drawings.

[Constitution of Permanent Magnet]

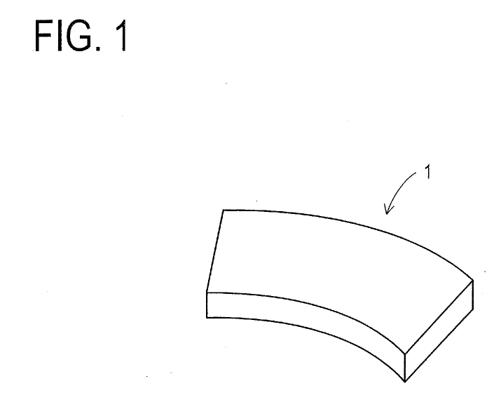

First, a constitution of a permanent magnet 1 according to the present invention will be described. FIG. 1 is an overall view of the permanent magnet 1 according to the present invention. Incidentally, the permanent magnet 1 depicted in FIG. 1 has a fan-like shape; however, the shape of the permanent magnet 1 may be changed according to the shape of a cutting-die.

As the permanent magnet 1 according to the present invention, an Nd—Fe—B-based magnet may be used. Incidentally, the contents of respective components are regarded as Nd: 27 to 40 wt %, B: 1 to 2 wt %, and Fe (electrolytic iron): 60 to 70 wt %. Furthermore, the permanent magnet 1 may include other elements such as Al, Cu, Ag, Dy, Tb, V, Mo, Zr, Ta, Ti, W, or Nb in small amount, in order to improve the magnetic properties thereof. FIG. 1 is an overall view of the permanent magnet 1 according to the present embodiment.

The permanent magnet 1 as used herein is a thin film-like permanent magnet having a thickness of 0.05 mm to 10 mm (for instance, 4 mm), and is prepared by sintering a green sheet formed from slurry-state magnet powder which is mixed with binder resin to be described later.

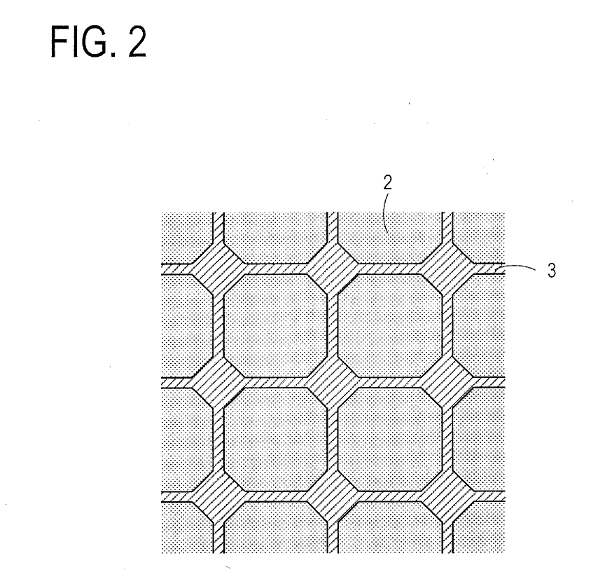

Further, as shown in FIG. 2, at a grain boundary (outer shell) of Nd crystal grains 2 constituting the permanent magnet 1 of the present invention, there is formed a layer 3 (referred to as outer shell layer 3, hereinafter) in which a part of Nd is replaced with Al, Cu, Ag, Dy, Tb, V, Mo, Zr, Ta, Ti, W, or Nb so that Dy or the like can be concentrated in grain boundaries of the Nd crystal grains 2. FIG. 2 is an enlarged view of the Nd crystal grains 2 constituting the permanent magnet 1.

Further, in the present invention, a part of Nd is replaced with Dy or the like by adding the organometallic compound containing the Dy or the like before forming milled magnet powder into a formed body to be described later. To be specific, in the step of wet-milling magnet material, magnet powder is mixed with the organic solvent in a wet state, wherein the organic solvent includes addition of an organometallic compound expressed with M-(OR)ₓ (M including at least one of Nd, Al, Cu, Ag, Dy, Tb, V, Mo, Zr, Ta, Ti, W, and Nb, R representing a substituent group consisting of a straight-chain or branched-chain hydrocarbon with carbon chain length of 2-16, and ₓ representing an arbitrary integer). The M-inclusive organometallic compound is Pentadecanoxyniobium (V) (Nb(OC₁₀H₂₁)₅), Pentatetradecanoxyniobium (V) (Nb(OC₁₄H₂₉)₅), Pentabutoxyniobium (V) (Nb(OC₄H₉)₅) or the like, for instance.

In a particular case where Dy or Tb is contained in the M which makes up the organometallic compound for wet-milling, the Dy-or-Tb-inclusive organometallic compound is dispersed in organic solvent so that the Dy-or-Tb-inclusive organometallic compound gets adhered to particle surfaces of Nd magnet powder efficiently. At the time of sintering the magnet powder to which the Dy-or-Tb-inclusive organometallic compound has been added, Dy or Tb contained in the organometallic compound that has uniformly adhered to the particle surface of Nd magnet powder by wet-dispersion diffusively intrudes into crystal growth regions of the Nd magnet particles and substitutes for Nd, to form the Dy layers or Tb layers as outer shell layer 3. Consequently, Dy or Tb can be concentrated in grain boundaries of the Nd crystal grains 2. Incidentally, the Dy layer may be composed of an intermetallic compound expressed as (DyₓNd₁₋ₓ)₂Fe₁₄B, for instance. Since the Dy or Tb concentrated in grain boundaries inhibits formation of reverse magnetic domain, coercive force of the magnet can be improved. Further, amount of to-be-added Dy or Tb can be reduced in comparison with conventional technology and decrease of residual magnetic flux density can be prevented.

Meanwhile, in a particular case where refractory metal elements such as V, Mo, Zr, Ta, Ti, W, Nb or the like (hereinafter, those are referred to as “Nb or the like”) are applicable to M in the expression, the Nb-or-the-like-inclusive organometallic compound is dispersed in organic solvent so that the Nb-or-the-like-inclusive organometallic compound uniformly gets adhered to particle surfaces of Nd magnet powder. At the time of sintering the magnet powder, the Nb or the like contained in the organometallic compound that has uniformly adhered to the particle surface of Nd magnet powder by wet-dispersion diffusively intrudes into crystal growth regions of the Nd magnet particles and substitutes for Nd, to form a refractory metal layer as outer shell layer 3 coating over surfaces of Nd crystal grains 2. In this connection, the refractory metal layer is made of NbFeB-based intermetallic compound. At the time of sintering the permanent magnet 1, the refractory metal layer coating over the surfaces of Nd crystal grains works as the means for preventing grain growth of the Nd crystal grains. Thereby, grain growth of crystal grains at the time of sintering can be prevented.

Further, it is preferable that crystal grain diameter of the Nd crystal grains 2 falls within a range of 0.1 μm through 5.0 μm. By making the crystal grain size in the sintered body significantly fine, magnetic characteristic can be improved. Especially, by approximating the crystal grain size to single-domain-particle size, magnetic characteristic can be improved significantly.

It is to be noted metal alkoxide is an example of an organometallic compound satisfying the general structural formula of M-(OR)ₓ (M including at least one of Nd, Al, Cu, Ag, Dy, Tb, V, Mo, Zr, Ta, Ti, W, and Nb, R representing a substituent group consisting of a straight-chain or branched-chain hydrocarbon with carbon chain length of 2-16, and ₓ representing an arbitrary integer). A metal alkoxide is expressed with general structural formula of M-(OR)ₙ (M: metal element, R: organic group and ₙ is a value of metal or semimetal). As examples of metal or semimetal to make up metal alkoxide, there are raised Nd, Pr, Dy, Tb, W, Mo, V, Nb, Ta, Ti, Zr, Ir, Fe, Co, Ni, Cu, Zn, Cd, Al, Ga, In, Ge, Sb, Y, lanthanide, etc. In the present invention, there are especially used Nd, Al, Cu, Ag, Dy, Tb, V, Mo, Zr, Ta, Ti, W, Nb, etc.

Kinds of alkoxide are not particularly restricted. As examples of alkoxide, there are raised methoxide, ethoxide, propoxide, isopropoxide, butoxide, alkoxide of which carbon number is 4 or larger, etc. Although not particularly restricted, kinds of alkoxide with low molecular weight are favorable in view of depressing residual carbon by thermal decomposition at low temperature, to be described later. Further, methoxide of which carbon number is 1 is easily decomposable and difficult to handle. Further, as will be described later, since alkoxide is used as disperser for wet-milling, it is preferable to use alkoxide in which carbon chain length of R is 2-16, more preferably, 10-14. More specifically, there can be raised butoxide of which carbon chain length is 4, hexoxide of which carbon chain length is 6, decanoxide of which carbon chain length is 10, tetradecanoxide of which carbon chain length is 14.

If carbon chain length is too long, an organometallic compound is difficult to get dissolved in a general purpose solvent such as toluene. Especially, carbon chain length of 17 or larger aggravates solubility so that the organometallic compound becomes difficult to get adhered to surfaces of Nd magnet particles uniformly. Therefore, carbon chain length preferably falls within a range of 16 or smaller, more preferably, 14 or smaller so that the organometallic compound gets adhered to surfaces of Nd magnet particles uniformly.

Use of an organometallic compound consisting of an alkyl group can facilitates thermal decomposition of the organometallic compound itself. More specifically, in the present invention, as organometallic compound to be added to magnet powder, it is preferable to use organometallic compound expressed with general structural formula of M-(OR)ₓ, (M including at least one of Nd, Al, Cu, Ag, Dy, Tb, V, Mo, Zr, Ta, Ti, W, and Nb, R representing an alkyl group consisting of a straight-chain or branched-chain alkyl with carbon chain length (alkyl chain length) of 2-16, and ₓ representing an arbitrary integer).

Further, sintering the formed body under proper sintering conditions can prevent M from diffusively intruding (diffusively setting) into main phases. Thereby, in the present invention, even if M is added, a region substituted with M can be restricted to the outer shell portion. Consequently, as the entirety of the crystal grains (i.e., as the entirety of sintered magnet), the Nd₂T₁₄B-based intermetallic compound phase can occupy large part of total volume. Thereby the thus composed magnet can prevent decrease of residual magnetic flux density (magnetic flux obtained when external magnetic field intensity is set to 0).

The permanent magnet 1 of the present invention is manufactured by sintering a green sheet formed from slurry-state magnet powder. For sintering the green sheet, pressure sintering method is used, for instance. As the means for pressure sintering the green sheet, there are hot pressing, hot isostatic pressing (HIP), high pressure synthesis, gas pressure sintering, spark plasma sintering (SPS) and the like, for instance. However, it is desirable to adopt a method where sintering is performed in a shorter duration and at a lower temperature, so as to prevent grain growth of the magnet particles during the sintering. It is also desirable to adopt a sintering method capable of suppressing warpage formed in the sintered magnets. Accordingly, specifically in the present invention, it is preferable to adopt the SPS method which is uniaxial pressure sintering in which pressure is uniaxially applied and also in which sintering is performed by electric current sintering, from among the above sintering methods.

Here, the SPS method is a method of heating a graphite sintering die with a sintering object arranged inside while pressurizing in a uniaxial direction. The SPS method utilizes pulse heating and mechanical pressure application, so that the sintering is driven complexly by electromagnetic energy by pulse conduction, self-heating of the object to be processed and spark plasma energy generated among particles, in addition to thermal or mechanical energy used for ordinary sintering. Accordingly, quicker heating and cooling can be realized, compared with atmospheric heating by an electric furnace or the like, and sintering at a lower temperature range can also be realized. As a result, the heating-up and holding periods in the sintering process can be shortened, making it possible to manufacture a densely sintered body in which grain growth of the magnet particles is suppressed. Further, the sintering object is sintered while being pressurized in a uniaxial direction, so that the warpage after sintering can be suppressed.

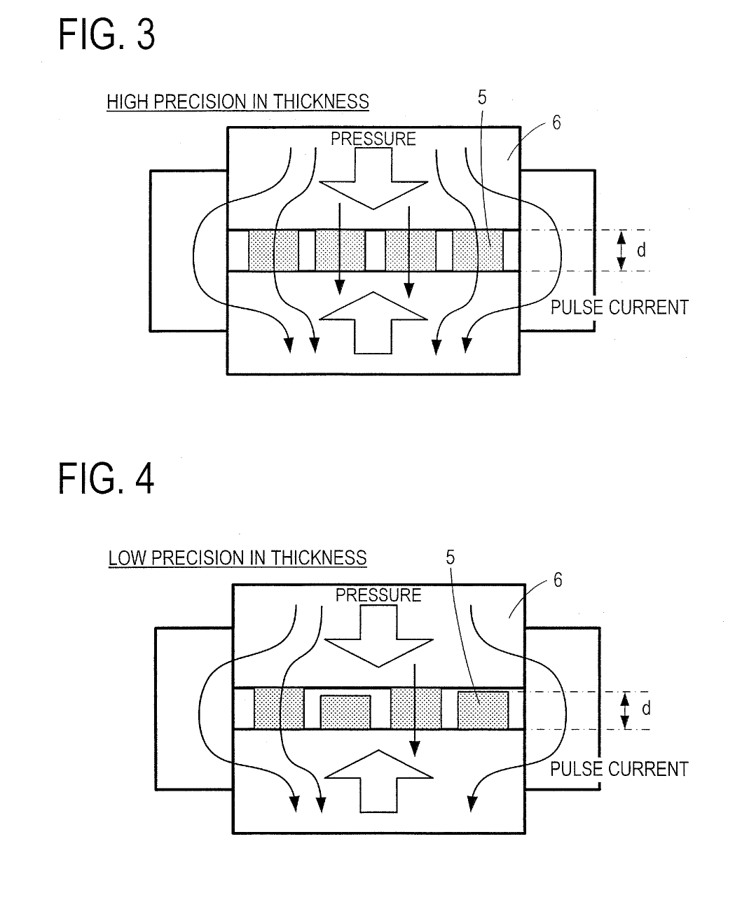

Furthermore, the green sheet is die-cut into a desired product shape (for instance, a fan-like shape shown in FIG. 1) to obtain a formed body and the formed body is arranged inside the sintering die of the SPS apparatus, upon executing the SPS method. According to the present invention, a plurality of formed bodies (for instance, ten formed bodies) 5 are arranged inside the sintering die 6 at a time, as depicted in FIG. 3, in order to boost the productivity. Although the plurality of formed bodies 5 are arranged inside a sintering die according to the example shown in FIG. 3, they may be arranged inside a plurality of sintering dies one by one. Even with the one-by-one arrangement manner, each of the upper and lower punches should be constituted integrally for pressing all the formed bodies 5 in their respective sintering dies (so that all the formed bodies 5 can be pressed simultaneously). Here, in the present invention, the green sheet is configured to have thickness precision within a margin of error of plus or minus 5%, preferably plus or minus 3%, or more preferably plus or minus 1%, with reference to a designed value. As a result, according to the present invention, as the thickness d of each formed body 5 is uniform, no inhomogeneity occurs at respective formed bodies 5 in pressure values and in temperatures when heated, so that the sintering can be performed satisfactorily even in a case where a plurality of formed bodies (for instance, ten formed bodies) 5 are arranged inside the sintering die 6 and sintered at a time, as illustrated in FIG. 3. Meanwhile, if the green sheet is formed with low precision in thickness (for instance, over plus or minus 5% with reference to the designed value), the thickness d of each formed body 5 is not uniform in the case where a plurality of formed bodies (for instance, ten formed bodies) 5 are arranged inside the sintering die 6 and sintered at a time as illustrated in FIG. 4. Accordingly, pulse current is unevenly dispersed through the respective formed bodies 5 and there occur inhomogeneities in pressure values or in temperatures when heated and the sintering cannot be performed satisfactorily.

In the present invention, as binder resin to be mixed with the magnet powder for preparing a green sheet, there are preferably used, for instance, polyisobutylene (PIB), butyl rubber (IIR), polyisoprene (IR), polybutadiene, polystyrene, styrene-isoprene block copolymer (SIS), styrene-butadiene block copolymer (SBS), Poly(2-methyl-1-pentene), poly(2-methyl-1-butene), poly(alpha-methylstyrene), polybutylmethacrylate, polymethylmethacrylate, etc. Incidentally, low molecular weight polyisobutylene is preferably added to the poly(alpha-methylstyrene) to produce flexibility. Further, as binder resin, there are preferably used polymers containing hydrocarbon and exhibiting depolymerization property and thermal decomposability (for instance, polyisobutylene, etc.) to reduce the oxygen content contained in the magnet.

Incidentally, the binder resin is preferably made of a resin excluding polyethylene and polypropylene so that the binder resin can get dissolved in a general purpose solvent such as toluene or the like.

Further, the amount of the binder resin to be added is an appropriate amount to fill the gaps between magnet particles so that thickness precision of the sheet can be improved when forming the slurry into a sheet-like shape. For instance, the binder resin proportion to the amount of magnet powder and binder resin in total in the slurry after the addition of the binder resin is preferably 4 to 40 wt %, more preferably 7 to 30 wt %, still more preferably 10 to 20 wt %.

Further, in the present invention, magnet material is wet-milled by using a bead mill or the like. In this connection, an organic solvent is generally used as solvent to be mixed with magnet material for wet milling. Accordingly, for obtaining a green sheet, the wet-milling makes it possible to prepare slurry-state magnet powder by adding a binder resin to an organic solvent containing milled magnet powder. Here, an organic solvent used for wet-milling may include: alcohols such as isopropyl alcohol, ethanol and methanol; lower hydrocarbons such as pentane and hexane; aromatic series such as benzene, toluene and xylene; esters such as ethyl acetate; ketones; and a mixture thereof. In the present invention, as will be described later, for reducing content of oxygen contained in the magnet, it is preferable to use one or more kinds of organic solvent selected from hydrocarbon-inclusive organic compounds. Here, as the one or more kinds of organic solvent selected from hydrocarbon-inclusive organic compounds, there are used toluene, hexane, pentane, benzene, xylene and a mixture thereof. For instance, toluene or hexane is used. Incidentally, the organic solvent may include a little amount of an organic compound other than hydrocarbon-inclusive organic compounds.

Further, in the present invention, at the time of wet-milling magnet material by method such as bead-mill, etc., any one of the above-mentioned organometallic compounds (e.g., Pentadecanoxyniobium (V), Pentatetradecanoxyniobium (V), Pentabutoxyniobium (V), etc.) is added as disperser. Thereby, the ability to finely wet-mill the magnet material can be improved and the improved wet-milling can mill most parts of the magnet material into fine particles (falling within fine particle size of 0.1 μm through 5.0 μm, for instance). Further, in the process of wet-milling, the thus finely milled magnet particles can concurrently get adhesion of the organometallic compound to surfaces thereof uniformly.

The wet-milled magnet powder may be dried at first and thereafter formed into slurry by adding an organic solvent and binder resin thereto. In that case, an organic solvent to be added to dried magnet powder is preferably an organic solvent including one or more of organic compounds containing hydrocarbon.

### [Method for Manufacturing Permanent Magnet]

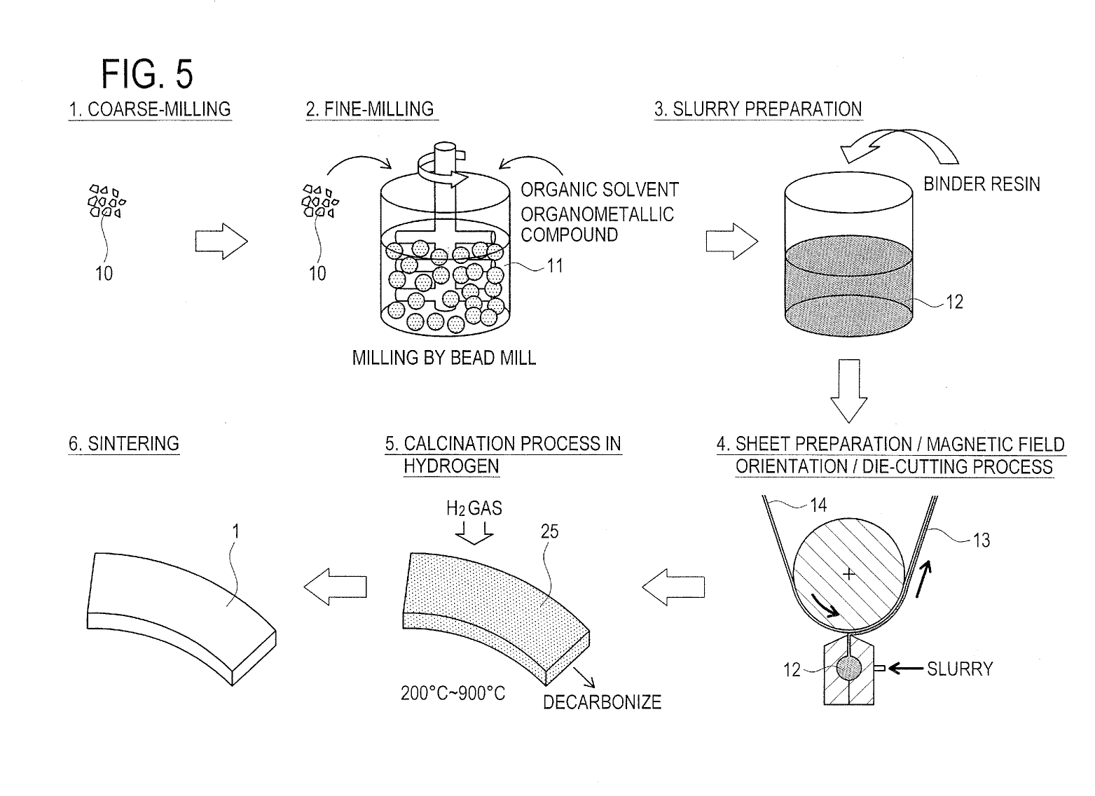

Next, a method for manufacturing the permanent magnet 1 according to the present invention will be described below with reference to FIG. 5. FIG. 5 is an explanatory view illustrating a manufacturing process of the permanent magnet 1 according to the present invention.

First, there is manufactured an ingot comprising Nd—Fe—B of certain fractions (for instance, Nd: 32.7 wt %, Fe (electrolytic iron): 65.96 wt %, and B: 1.34 wt %). Thereafter the ingot is coarsely milled using a stamp mill, a crusher, etc. to a size of approximately 200 μm. Otherwise, the ingot is dissolved, formed into flakes using a strip-casting method, and then coarsely milled using a hydrogen pulverization method. Thereby, coarsely milled magnet powder 10 is obtained.

Next, the coarsely milled magnet powder 10 is finely wet-milled into a range of fine particle size (e.g., 0.1 μm through 5.0 μm) by bead mill and the finely wet-milled magnet powder is dispersed into the solvent so as to prepare a disperse solution 11. Further, in the process of wet-milling, an organometallic compound containing any one of Nd, Al, Cu, Ag, Dy, Tb, V, Mo, Zr, Ta, Ti, W, and Nb is added to the solvent as disperser.

Detailed wet-milling conditions are as follows:
Pulverizing Apparatus: bead mill
Pulverizing Media: pulverizing for two hours with φ 2-mm zirconia beads and further pulverizing for two hours with φ 0.5-mm zirconia beads

It is preferable to use an organometallic compound that satisfies general structural formula of M-(OR)ₓ, (M including at least one of Nd, Al, Cu, Ag, Dy, Tb, V, Mo, Zr, Ta, Ti, W, and Nb, R representing an alkyl group consisting of a straight-chain or branched-chain with carbon chain length of 2-16, and ₓ representing an arbitrary integer), as an organometallic compound to be dissolved (for instance, Pentadecanoxyniobium (V) Pentatetradecanoxyniobium (V) Pentabutoxyniobium (V), etc.). Further, the solvent for wet-milling is an organic solvent. An organic solvent is preferably prepared by selecting one or more of hydrocarbon-inclusive organic compounds. For instance, there may be used toluene, hexane, pentane, benzene, xylene, or a mixture of those. In the present invention, especially, toluene or hexane is used. Although amount of an organometallic compound to be added is not particularly restricted, the amount of the organometallic compound is set to 0.1 to 10 of part with reference to magnet powder, preferably, 0.2 to 8 of part, more preferably 0.5 to 5 of part (1 of part, for instance) so that the organometallic compound properly serves as disperser and gets uniformly adhered to particle surfaces of magnet powder.

After that, binder resin is further added to the disperse solution 11. Through this, there is prepared slurry 12 which is a mixture of the binder resin, the organic solvent and finely milled magnet material of which particle surfaces get uniform adhesion of the organometallic compound. Here, binder resin preferably takes a form of polymer consisting of hydrocarbon and exhibiting depolymerization property and thermally decomposable property, as described in the above. For instance, isobutylene is used as resin binder. Incidentally, binder resin diluted with a solvent may be added. The amount of binder resin to be added is preferably determined so as to satisfy the following proportional range: proportion of binder resin with reference to the total amount of magnet powder and binder resin contained in the slurry falling within a range of 4 to 40 wt %; more preferably 7 to 30 wt %; still more preferably 10 to 20 wt %. Here, binder resin is to be added in an atmosphere composed of inert gas such as nitrogen gas, Ar gas or He gas.

Subsequently, a green sheet 13 is formed from the slurry 12 thus produced. The green sheet 13 may be formed by, for instance, a coating method in which the produced slurry 12 is spread on a supporting base 14 such as a separator as needed by an appropriate system and then desiccated. Incidentally, the coating method is preferably a method excellent in layer thickness controllability, such as a doctor blade system, a slot-die system, or a comma coating system. For realizing thickness precision, a slot-die system or a comma coating system is especially favorable as being excellent in layer thickness controllability (namely, as being a method capable of applying a layer with accurate thickness on a surface of a base). For instance, the following embodiment adopts a slot-die system. As supporting base 14, a silicone-treated polyester film is used. Further, a green sheet 13 is dried by being held at 90 degrees Celsius for 10 minutes and subsequently at 130 degrees Celsius for 30 minutes. Further, a defoaming agent may preferably be used in conjunction therewith to sufficiently perform defoaming treatment so that no air bubbles remain in a spread layer.

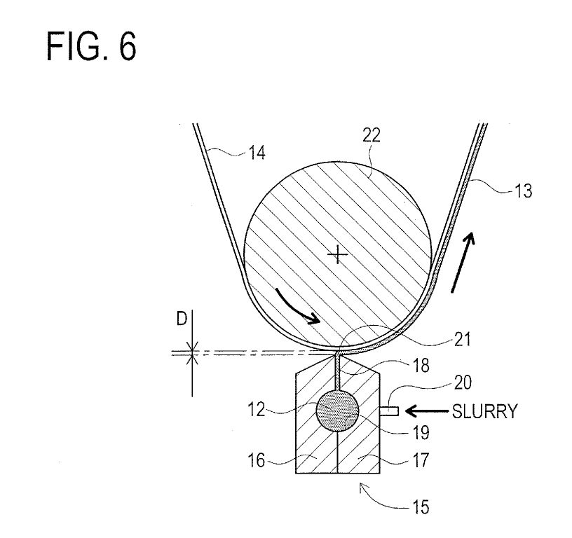

Here will be given a detailed description of the formation process of a green sheet 13 using a slot-die system referring to FIG. 6. FIG. 6 is an explanatory diagram illustrating the formation process of the green sheet 13 using the slot-die system.

As illustrated in FIG. 6, a slot die 15 used for the slot-die system is formed by putting blocks 16 and 17 together. There, a gap between the blocks 16 and 17 serves as a slit 18 and a cavity (liquid pool) 19. The cavity 19 communicates with a die inlet 20 formed in the block 17. Further, the die inlet 20 is connected with a slurry feed system configured with a metering pump and the like (not shown), and the cavity 19 receives the feed of metered slurry 12 through the die inlet 20 by the metering pump and the like. Further, the slurry 12 fed to the cavity 19 is delivered to the slit 18, and discharged at a predetermined coating width from a discharge outlet 21 of the slit 18, with a pressure which is uniform in transverse direction in a constant amount per unit of time. Meanwhile, a supporting base 14 is conveyed along the rotation of a coating roll 22 at a predetermined speed. As a result, the discharged slurry 12 is laid down on the supporting base 14 with a predetermined thickness.

Further, in the formation process of the green sheet 13 by the slot-die system, it is desirable to measure the actual sheet thickness of the green sheet 13 after coating, and to perform feed back control of a gap D between the slot die 15 and the supporting base 14 based on the measured thickness. Further, it is desirable to minimize the variation in feed rate of the slurry supplied to the slot die 15 (for instance, suppress the variation within plus or minus 0.1%), and in addition, to also minimize the variation in coating speed (for instance, suppress the variation within plus or minus 0.1%). As a result, thickness precision of the green sheet can further be improved. Incidentally, the thickness precision of the formed green sheet 13 is within a margin of error of plus or minus 5% with reference to a designed value (for instance, 4 mm), preferably within plus or minus 3%, or more preferably within plus or minus 1%.

Incidentally, a preset thickness of the green sheet 13 is desirably within a range of 0.05 mm through 10 mm. If the thickness is set to be thinner than 0.05 mm, it becomes necessary to accumulate many layers, which lowers the productivity. Meanwhile, if the thickness is set to be thicker than 10 mm, it becomes necessary to decrease the drying rate so as to inhibit air bubbles from forming at drying, which significantly lowers the productivity.

Further, a pulsed field is applied before drying to the green sheet 13 coated on the supporting base 14, in a direction intersecting a transfer direction. The intensity of the applied magnetic field is 5000 [Oe] through 150000 [Oe], or preferably 10000 [Oe] through 120000 [Oe]. Incidentally, the direction to orient the magnetic field needs to be determined taking into consideration the magnetic field direction required for the permanent magnet 1 formed from the green sheet 13, but is preferably in-plane direction.

Then, the green sheet 13 made from the slurry 12 is formed into a desired product shape (for example, the fan-like shape shown in FIG. 1) to form a formed body 25.

Thereafter, the formed body 25 is held at a binder-resin-decomposition temperature for several hours (for instance, five hours) in a non-oxidizing atmosphere (specifically in this invention, a hydrogen atmosphere or a mixed gas atmosphere of hydrogen and inert gas) and a calcination process in hydrogen is performed. The hydrogen feed rate during the calcination is, for instance, 5 L/min, if the calcination is performed in the hydrogen atmosphere. By the calcination process in hydrogen, the binder resin can be decomposed into monomers through depolymerization reaction, released therefrom and removed. Namely, so-called decarbonization is performed in which carbon content in the formed body 25 is reduced. Furthermore, calcination process in hydrogen is to be performed under such a condition that carbon content in the formed body 25 is 1500 ppm or lower, or more preferably 1000 ppm or lower. Accordingly, it becomes possible to densely sinter the permanent magnet 1 as a whole in the following sintering process, and the decrease in the residual magnetic flux density or in the coercive force can be prevented.

The binder-resin-decomposition temperature is determined based on the analysis of the binder resin decomposition products and decomposition residues. In particular, the temperature range to be selected is such that, when the binder resin decomposition products are trapped, no decomposition products except monomers are detected, and when the residues are analyzed, no products due to the side reaction of remnant binder components are detected. The temperature differs depending on the type of binder resin, but may be set at 200 through 900 degrees Celsius, or more preferably 400 through 600 degrees Celsius (for instance, 600 degrees Celsius).

Incidentally, the formed body 25 calcined in a hydrogen atmosphere may be subsequently held in a vacuum atmosphere so as to perform dehydrogenation treatment. In the dehydrogenation treatment, NdH₃ (high activity) contained in the formed body 25 prepared through in-hydrogen calcination is gradually changed to NdH₂ (low activity) so as to decrease activity level of the calcined body 82 activated by in-hydrogen calcination process. Thereby, even though the calcined body 82 calcined in hydrogen atmosphere is moved in the air, the dehydrogenation process prevents Nd from binding with oxygen and decrease of residual magnetic flux and coercive force can be avoided

Thereafter, a sintering process is performed in which the formed body 25 calcined in the calcination process in hydrogen is sintered. In the present invention, pressure sintering is applied to the calcined formed body 25. The pressure sintering includes, for instance, hot pressing, hot isostatic pressing (HIP), high pressure synthesis, gas pressure sintering, spark plasma sintering (SPS) and the like. However, it is preferable to adopt the spark plasma sintering which is uniaxial pressure sintering in which pressure is uniaxially applied and also in which sintering is preformed by electric current sintering so as to prevent grain growth of the magnet particles during the sintering and also to prevent warpage formed in the sintered magnets.

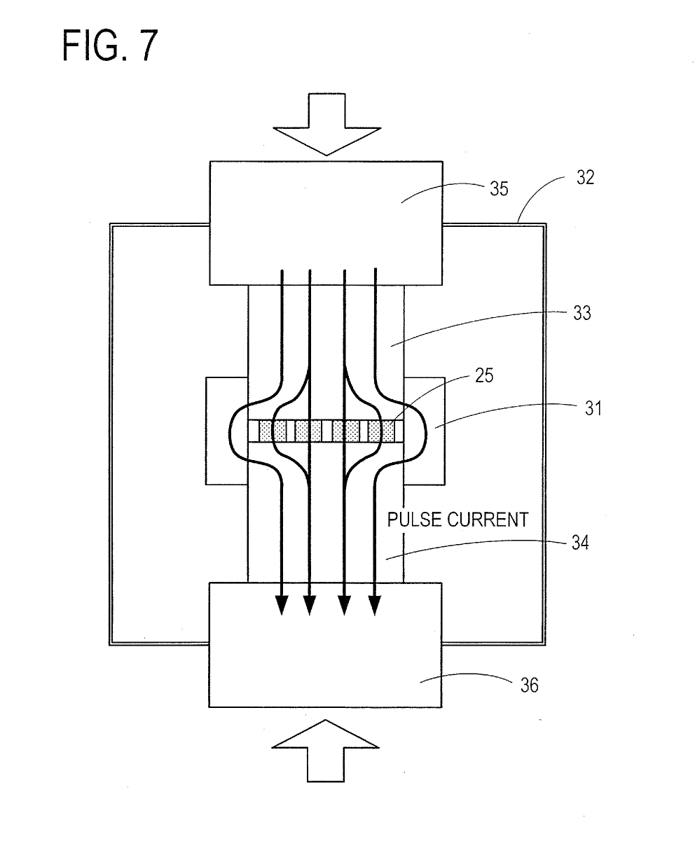

Here will be given a detailed description of the pressure sintering process of a formed body 25 using the SPS method, referring to FIG. 7. FIG. 7 is a schematic diagram depicting the pressure sintering process of the formed body 25 using the SPS method.

When performing the spark plasma sintering as illustrated in FIG. 7, first, the formed body 25 is put in a graphite sintering die 31. Incidentally, the above calcination process in hydrogen may also be performed under the state where the formed body 25 is put in the sintering die 31. Then, the formed body 25 put in the sintering die 31 is held in a vacuum chamber 32, and an upper punch 33 and a lower punch 34 also made of graphite are set thereat. After that, using an upper punch electrode 35 coupled to the upper punch 33 and a lower punch electrode 36 coupled to the lower punch 34, pulsed DC voltage/current being low voltage and high current is applied. At the same time, a load is applied to the upper punch 33 and the lower punch 34 from upper and lower directions using a pressurizing mechanism (not shown). As a result, the formed body 25 put inside the sintering die 31 is sintered while being pressurized. Further, the spark plasma sintering is preferably executed to a plurality of formed bodies (for instance, ten formed bodies) 25 simultaneously, so that the productivity may be improved. Incidentally, at the simultaneous spark plasma sintering to the plurality of formed bodies 25 exemplarily shown in FIG. 7, the plurality of formed bodies 25 are put in one sintering die 31, however, they may be arranged in different sintering dies 31, respectively. Incidentally, in the case that the plurality of formed bodies 25 are respectively arranged in different sintering dies 31, the upper punch 33 and the lower punch 34 for pressing the formed bodies 25 are configured to be integrally used for the plurality of sintering dies 31 (so that the pressure can be applied simultaneously by the upper punch 33 and the lower punch 34) which are integrally-moving.

Incidentally, the detailed sintering condition is as follows:
Pressure value: 30 MPa
Sintering temperature: raised by 10 deg. C. per min. up to 940 deg. C. and held for 5 min.
Atmosphere: vacuum atmosphere of several Pa or lower.

After the spark plasma sintering, the formed body 25 is cooled down, and again undergoes a heat treatment in 600 through 1000 degrees Celsius for two hours. As a result of the sintering, the permanent magnet 1 is manufactured.

### EMBODIMENT

Here will be described on embodiments according to the present invention referring to comparative examples for comparison.

### Embodiment 1

In the embodiment 1, there is used a Nd—Fe—B-based magnet and alloy composition thereof is Nd/Fe/B=32.7/65.96/1.34 in wt %. Toluene has been used as organic solvent for wet-milling process. At the time of wet-milling, 1-part of Pentadecanoxyniobium (V) (Nb(OC₁₀H₂O₅) has been added as organometallic compound with reference to magnet powder. In the course of wet-milling, the magnet powder has been at first pulverized for two hours with φ 2-mm zirconia beads and further pulverized for two hours with φ 0.5-mm zirconia beads. Polyisobutylene as binder resin have been used to prepare slurry containing 16.7 wt % of binder resin with reference to the total weight of the magnet powder and the binder resin. After that, a green sheet has been manufactured by a slot-die system in which the thus obtained slurry has been spread on a base and the thus obtained green sheet has been die-cut into a desired shape for product. Other processes are the same as the processes in [Method for Manufacturing Permanent Magnet] mentioned above.

### Embodiment 2

As organometallic compound to be added at the time of wet-milling, Pentatetradecanoxyniobium (V) (Nb(OC₁₄H₂₉)₅) has been used. Other conditions are the same as the other embodiments.

### Embodiment 3

As organometallic compound to be added at the time of wet-milling, Pentabutoxyniobium (V) (Nb(OC₄H₉)₅) has been used. Other conditions are the same as the other embodiments.

### Comparative Example 1

Wet-milling has been performed without adding an organometallic compound. Other conditions are the same as Embodiment 1.

### Comparative Example 2

As organometallic compound to be added at the time of wet-milling, 1-Pentaeicosoxyniobium (V) (Nb(OC₂₀H₄₁)₅) has been used. Other conditions are the same as the other embodiments.

### (Comparison Between Embodiments and Comparative Examples)

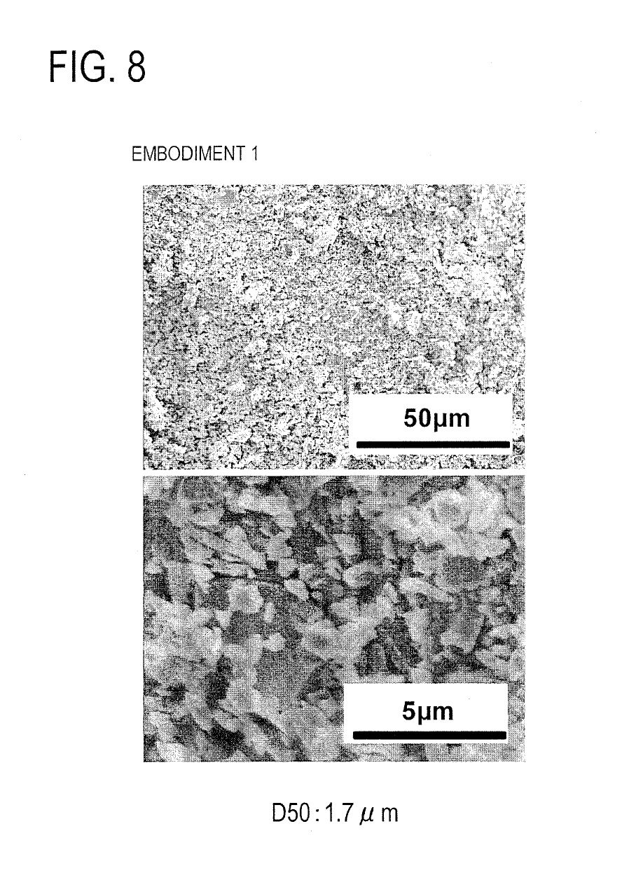

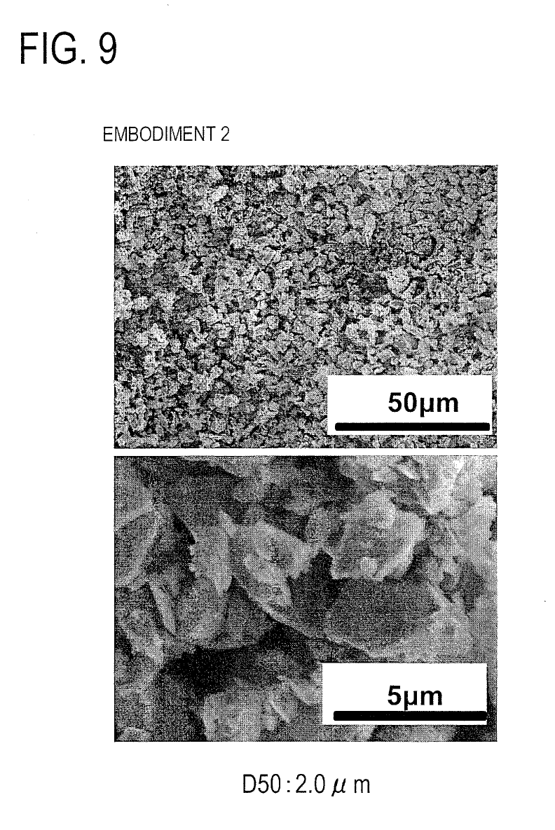

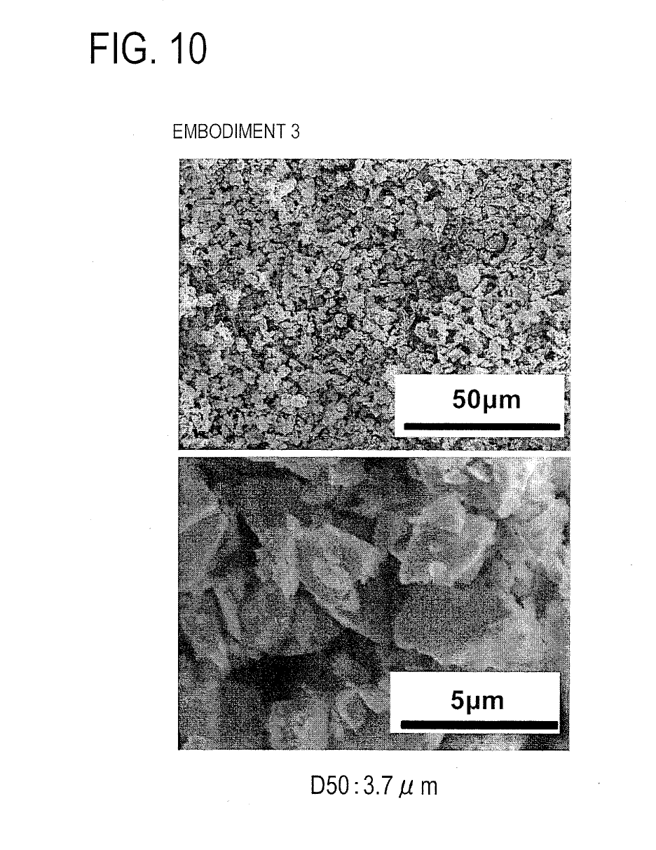

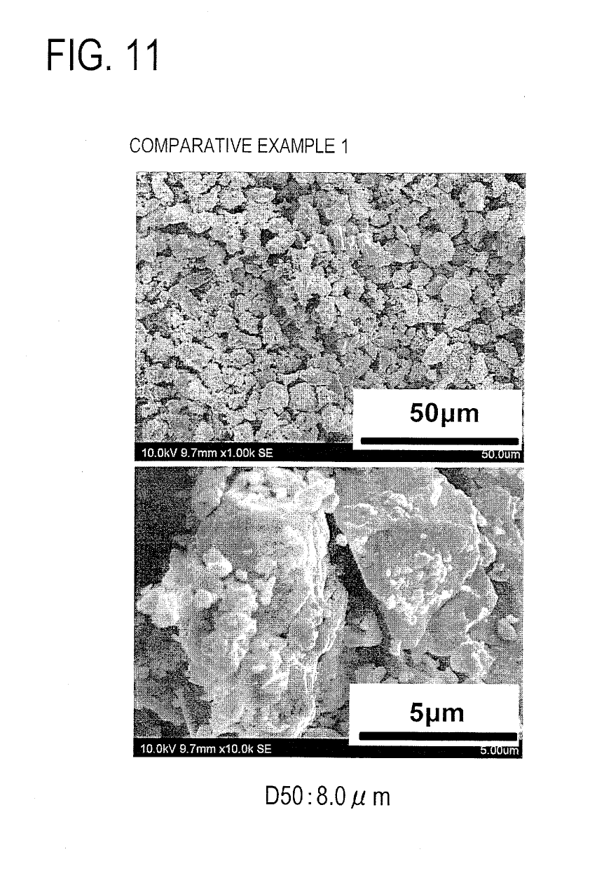

Each of FIG. 8 through FIG. 11 is an enlarged image of wet-milled magnet powder. Regarding each of permanent magnets of Embodiments 1 through 3 and comparative example 1, particle size distribution has been measured and obtained D50 (median diameter).

Comparison of those enlarged images reveals significant particle size difference between embodiments 1 through 3 and comparative example 1. That is, in comparison with milled magnet material of the comparative example 1 in which an organometallic compound has not been added for wet-milling, magnet material has been milled into significantly fine particles with respect to the embodiments 1 through 4 in each of which an organometallic compound has been added for wet-milling. To be specific, the embodiments 1, 2 and 3 have respectively obtained 1.7-μm, 2.0-μm and 3.7-μm long D50, wherein most of magnet material has been finely milled into magnet powder having particle diameter size falling within 0.1-μm to 5.0-μm long. Meanwhile, the comparative example 1 has obtained 8.0-μm long D50, which reveals that the comparative example 1 has failed to mill magnet material into fine magnet powder having particle diameter size falling within 0.1-μm to 5.0-μm long.

As a result, regarding each of the permanent magnets of the embodiments 1 through 3, sintered crystal particle diameter can be made fine in comparison with the permanent magnet of the comparative example 1 and magnetic properties can be improved.

The comparative example 2 has failed to dissolve 1-Pentaeicosoxyniobium (V) into toluene. That is, the comparative example 2 reveals that, in a case where carbon chain length of an organometallic compound is too long, the organometallic compound is difficult to get dissolved into a general purpose solvent such as toluene.

From the above results, it has been revealed that the organometallic compounds added at the respective embodiments 1 through 3 have worked as disperser and helped improve the ability to finely wet-mill magnet powder. Especially, in a case of using an organometallic compound of which carbon chain length in R of substituent group is 2-16, the organometallic compound can mill the most of magnet material into fine magnet powder having particle diameter falling within 0.1-μm to 5.0-μm long while getting uniformly adhered to particle surfaces of magnet powder.

When the embodiments 1 through 3 are compared, the embodiment 2 can mill magnet material more finely than the embodiment 3 and the embodiment 1 can mill magnet material even more finely than the embodiment 2. Accordingly, the results of the embodiments 1 through 3 reveal that the ability to finely wet-mill magnet material can be improved by using Pentadecanoxyniobium (V) and Pentatetradecanoxyniobium (V) respectively having carbon chain length of 10 and 14 in R of substituent group, the carbon chain length 10 and 14 being longer than Pentabutoxyniobium (V) having carbon chain length of 4 in R of substituent group. It is to be noted that the ability to finely wet-mill magnet material varies depending on carbon chain length of R of substituent group contained in the organometallic compound and the ability can be improved by using an organometallic compound having carbon chain length of 2-16, more preferably 6-14, still more preferably 10-14.

As described in the above, regarding the permanent magnet 1 and the manufacturing method of the permanent magnet 1, coarsely milled magnet material is finely wet-milled in an organic solvent together with an organometallic compound expressed with a structural formula of M-(OR)ₓ (M including at least one of Nd, Al, Cu, Ag, Dy, Tb, V, Mo, Zr, Ta, Ti, W, and Nb, R representing a substituent group consisting of a straight-chain or branched-chain hydrocarbon with carbon chain length of 2-16, and ₓ representing an arbitrary integer), to obtain magnet powder of the magnet material currently milled and to make the organometallic compound adhere to particle surfaces of the magnet powder. Subsequently, the magnet powder having adhesion of the organometallic compound to particle surfaces thereof is formed into a formed body so as to obtain a permanent magnet 1. By wet-milling the magnet material in the organic solvent together with the organometallic compound, the ability to finely wet-mill the magnet material can be improved. For instance, most parts of the magnet material can be milled into fine particles (falling within fine particle size range of 0.1 μm through 5.0 μm, for instance). Consequently, diameter of sintered crystal particles can be made significantly tiny and magnetic performance can be improved.

Further, by using an organometallic compound of which carbon chain length is 2-16, the above such configured organometallic compound can get dissolved into a general purpose solvent such as toluene and proper adhesion of the organometallic compound on particle surface of the magnet powder can be made.

Further, the organometallic compound containing Nd, Al, Cu, Ag, Dy, Tb, V, Mo, Zr, Ta, Ti, W, Nb, etc. is added so that the organometallic compound gets adhered to particle surface of magnet powder and the magnet powder with adhesion of the organometallic compound is subsequently sintered. Therefore, in a case of adding elements such as Nd, Al, Cu, Ag, Dy, Tb, V, Mo, Zr, Ta, Ti, W, Nb, etc., respective elements can be efficiently concentrated in grain boundaries of the magnet. Thereby, magnetic performance of the permanent magnet can be improved. Further, since amount of elements to be added to the magnet can be lessened in comparison with amount to be added to a conventional magnet, decrease of residual magnetic flux can be prevented.

Further, the permanent magnet is obtained by sintering a green sheet formed from slurry prepared by mixing the magnet powder, the organic solvent and binder resin together. Therefore, the thus obtained green sheet uniformly contracts through sintering and deformations such as warpage and depressions do not occur there. Further, the sintered green sheet having uniformly contracted gets pressed uniformly, which eliminates adjustment process to be conventionally performed after sintering and simplifies manufacturing process. Thereby, a permanent magnet can be manufactured at highly accurate dimension. Further, even if above such permanent magnets are manufactured thin, increase in the number of manufacturing processes can be avoided without lowering a material yield.

Further, in the embodiment, before sintering the green sheet, the binder resin is thermally decomposed and removed from the green sheet by holding green sheet for a predetermined length of time at binder-resin-decomposition temperature in a non-oxidizing atmosphere. Thereby, carbon content in the magnet can be reduced previously. Consequently, previous reduction of carbon content can prevent alpha iron from separating out in a main phase of the sintered magnet and entirety of the magnet can be sintered densely. Thereby, decrease in the coercive force can be prevented.

Especially, by using an organometallic compound consisting of an alkyl group as to-be-added organometallic compound, thermal decomposition of the organometallic compound can be performed at low temperature before calcining magnet powder in a hydrogen atmosphere. Thereby, thermal decomposition of the organometallic can be easily performed on the entirety of magnet particles at ease.

Further, the green sheet to which the binder resin has been mixed is calcined in a hydrogen atmosphere or a mixed gas atmosphere of hydrogen and inert gas at temperature range of 200 degrees Celsius to 900 degrees Celsius, more preferably, at temperature range of 400 degrees Celsius to 600 degrees Celsius. Thereby, carbon content in the magnet can be reduced reliably.

Not to mention, the present invention is not limited to the above-described embodiments but may be variously improved and modified without departing from the scope of the present invention.

For instance, of magnet powder, milling condition, mixing condition, calcination condition, sintering condition, etc. are not restricted to conditions described in the embodiment. In the above embodiment, to obtain the inventive permanent magnet, magnet powder is made into a slurry state to prepare green sheet and the thus prepared green sheet is sintered, for instance. Alternatively, wet-milled magnet powder may be dried and subsequently sintered according to powder sinter method to obtain a permanent magnet. Further, a formed body may be obtained according to injection molding, metal rolling system, extrusion molding, etc. In the above-mentioned embodiment, the green sheet is formed in accordance with a slot-die system. However, a green sheet may be formed in accordance with other system or molding (e.g., comma coating system, injection molding, extruding system, metallic molding, doctor blade system, etc.), as long as it is the system that is capable of spreading slurry on a base at high accuracy. Further, sintering method is not restricted to pressure sintering but vacuum sintering is applicable. In the above embodiment, magnet powder is wet-milled by using a wet-type bead mill. However, other wet-mill system may be applied. For instance, a nanomizer may be used.

In the above description, to make magnet powder into a slurry state, binder resin is added to the organic solvent containing wet-milled magnet powder. However, magnet powder may be made into a slurry state in such a manner that wet-milled magnet powder is dried once and thereafter mixed with an organic solvent and binder resin. When taking the above slurry preparation steps, regarding organic solvent to be added to the once-dried magnet powder, it is preferable to use one or more kinds of organic solvent selected from hydrocarbon-inclusive organic compounds.

In the embodiments, toluene or hexane is used as organic solvent to be added to the magnet powder. However, other organic solvent may be used. For instance, there may be used pentane, benzene, xylene and a mixture thereof.

The embodiments 1 and 2 respectively use Pentadecanoxyniobium (V) and Pentabutoxyniobium (V) as examples of organometallic compounds containing Nd, Al, Cu, Ag, Dy, Tb, V, Mo, Zr, Ta, Ti, W, Nb, etc. which are to be added to an organic solvent for wet-milling magnet powder. However, other organometallic compounds may be used as long as being organometallic compounds that satisfy general structural formula of M-(OR)ₓ, (M including at least one of Nd, Al, Cu, Ag, Dy, Tb, V, Mo, Zr, Ta, Ti, W, and Nb, R representing a substituent group consisting of a straight-chain or branched-chain hydrocarbon with carbon chain length of 2-16, and ₓ representing an arbitrary integer). Further, M in the general structural formula may contain element other than the above specified metallic elements.

Description of the present invention has been given by taking the example of the Nd—Fe—B-based magnet. However, a magnet made of other kinds of material may be used. Further, in the embodiments of present invention, the proportion of Nd component ratio with reference to the alloy composition of the magnet is set higher in comparison with Nd component ratio in accordance with the stoichiometric composition. The proportion of Nd component may be set the same as the alloy composition according to the stoichiometric composition.

### DESCRIPTION OF REFERENCE NUMERALS AND SIGNS

1 permanent magnet
10 coarsely milled magnet powder
11 disperse solution
12 slurry
13 green sheet
25 formed body

1. A rare-earth permanent magnet manufactured through steps of:
wet-milling magnet material in an organic solvent together with an organometallic compound expressed with a structural formula of
M-(OR)ₓ
(M including at least one of Nd, Al, Cu, Ag, Dy, Tb, V, Mo, Zr, Ta, Ti, W, and Nb, R representing a substituent group consisting of a straight-chain or branched-chain hydrocarbon with carbon chain length of 2-16, and ₓ representing an arbitrary integer)
to obtain magnet powder of the magnet material currently milled and to make the organometallic compound adhere to particle surfaces of the magnet powder;
forming the magnet powder having the organometallic compound adhered to particle surfaces thereof into a formed body; and
sintering the formed body.

2. The rare-earth permanent magnet according to claim 1, wherein R in the structural formula is an alkyl group.

3. The rare-earth permanent magnet according to claim 1, wherein, in the step of forming the magnet powder into the formed body,
a slurry is prepared by mixing the magnet powder, the organic solvent and binder resin, and
the slurry is formed into a sheet-like shape so as to obtain a green sheet as the formed body.

4. The rare-earth permanent magnet according to claim 3, wherein, before the step of sintering the formed body, the binder resin is decomposed and removed from the formed body by holding the formed body for a predetermined length of time at binder resin decomposition temperature in a non-oxidizing atmosphere.

5. The rare-earth permanent magnet according to claim 4, wherein, when decomposing and removing the binder resin from the formed body, the formed body is held for the predetermined length of time at temperature range of 200 degrees Celsius to 900 degrees Celsius in a hydrogen atmosphere or a mixed gas atmosphere of hydrogen and inert gas.

6. A manufacturing method of a rare-earth permanent magnet comprising steps of:
wet-milling magnet material in an organic solvent together with an organometallic compound expressed with a structural formula of
M-(OR)ₓ
(M including at least one of Nd, Al, Cu, Ag, Dy, Tb, V, Mo, Zr, Ta, Ti, W, and Nb, R representing a substituent group consisting of a straight-chain or branched-chain hydrocarbon with carbon chain length of 2-16, and ₓ representing an arbitrary integer)
to obtain magnet powder of the magnet material currently milled and to make the organometallic compound adhere to particle surfaces of the magnet powder;
forming the magnet powder having the organometallic compound adhered to particle surfaces thereof into a formed body; and
sintering the formed body.

7. The manufacturing method of a rare-earth permanent magnet according to claim 6, wherein R in the structural formula is an alkyl group.

8. The manufacturing method of a rare-earth permanent magnet according to claim 6, wherein, in the step of forming the magnet powder into the formed body,
a slurry is prepared by mixing the magnet powder, the organic solvent and binder resin, and
the slurry is formed into a sheet-like shape so as to obtain a green sheet as the formed body.

9. The manufacturing method of a rare-earth permanent magnet according to claim 8, wherein, before the step of sintering the formed body, the binder resin is decomposed and removed from the formed body by holding the formed body for a predetermined length of time at binder resin decomposition temperature in a non-oxidizing atmosphere.

10. The manufacturing method of a rare-earth permanent magnet according to claim 9, wherein, when decomposing and removing the binder resin from the formed body, the formed body is held for the predetermined length of time at temperature range of 200 degrees Celsius to 900 degrees Celsius in a hydrogen atmosphere or a mixed gas atmosphere of hydrogen and inert gas.
